(19) United States
(12) Patent Application Publication
(10) Pub. No.: US 2024/0336229 A1
(43) Pub. Date: Oct. 10, 2024

(54) VEHICLE ROOF MODULE FOR A SENSOR

(71) Applicant: INALFA ROOF SYSTEMS GROUP B.V., Oostrum (NL)

(72) Inventors: Bob Hubertus Marcus Maria Aarts, Roermond (NL); Thomas Anton Martijnszoon Albers, Venray (NL)

(21) Appl. No.: 18/624,807

(22) Filed: Apr. 2, 2024

(30) Foreign Application Priority Data
Apr. 5, 2023 (EP) 23166826.0

(51) Int. Cl. B60S 1/08; B60S 1/20; B60S 1/34

(52) U.S. Cl. CPC B60S 1/08; B60S 1/20; B60S 1/3465

(57) ABSTRACT

The disclosure relates to a vehicle roof module for a sensor. The module includes a wiper assembly with a wiper blade carried on a wiper arm, and a sensor housing with a visor, and a sensor having a field of view aligned with the visor, The roof module further includes a guide defining a wiping path and a parking path and a slide configured for sliding the wiper assembly over the guide along the wiping path and the parking path. When sliding the wiper assembly over the wiping path slides the wiper arm along the sensor housing such that the wiper blade wipes the visor and when sliding the wiper assembly over the parking path slides the wiper arm along the sensor housing while the wiper blade is lifted from the visor.

### CROSS-REFERENCE TO RELATED APPLICATION

The present application is based on and claims the benefit of European patent application Serial No. 23166826.0, filed Apr. 5, 2023, the content of which is hereby incorporated by reference in its entirety.

### BACKGROUND

The discussion below is merely provided for general background information and is not intended to be used as an aid in determining the scope of the claimed subject matter.

Aspects of the invention relate to a vehicle roof module for a sensor such as a LiDAR sensor or other light sensitive sensor. In particular, aspects of the invention relate to a cleaning assembly for a screen of a housing enclosing such a sensor.

The discussion below is merely provided for general background information and is not intended to be used as an aid in determining the scope of the claimed subject matter.

In support of driving assistance for vehicles and for the further aim of autonomous driving of vehicles, sensors for image recognition, for example of road and traffic signs, are being mounted on such vehicles. Thereto, the sensor may be placed within a sensor housing on top of the roof of a vehicle to provide a wide field of view. The sensor housing will have a front screen or visor to provide a light sensitive sensor, such as a LiDAR sensor, with an unobstructed field of view. As with any other vehicle screen or visor, such as head lights or front wind shield, dirt and dust may accumulate over time on the screen. In order to ensure proper operation and maintain a clear field of view, the screen or visor may need to be cleaned over time. Though wipers may be applied with such screens, a problem therewith is that these could interfere with the field of view of the sensor.

### SUMMARY

This Summary and the Abstract herein are provided to introduce a selection of concepts in a simplified form that are further described below in the Detailed Description. This Summary and the Abstract are not intended to identify key features or essential features of the claimed subject matter, nor are they intended to be used as an aid in determining the scope of the claimed subject matter. The claimed subject matter is not limited to implementations that solve any or all disadvantages noted in the Background.

When not used to wipe the visor of the sensor housing, the wiper is preferably in a position that allows for a clear field of view of the sensor. In addition, the wiper is preferably in a position that does not protrude from the sensor housing. As this may either result in wind noise, in the wiper accumulating dirt and dust, and/or leaves the wiper being prone to fracture or tampering. In particular, the wiper blade or lip of the wiper blade may be prone to wear and tear. Accordingly, it is preferred to shield the wiper when not in use in order to prolong the lifetime and preserve proper functioning of the wiper.

A vehicle roof module includes a sensor housing. The vehicle roof module further includes a wiper assembly with a wiper blade on a wiper arm, a sensor housing with a visor, and a guide defining a wiping path and a parking path. The roof module further includes a slide configured to slide the wiper assembly over the guide along the wiping path and the parking path. When sliding the wiper assembly over the wiping path slides the wiper arm along the sensor housing such that the wiper blade wipes the visor and when sliding the wiper assembly over the parking path slides the wiper arm along the sensor housing while the wiper blade is lifted from the visor.

As the material of the blade of the wiper, such as e.g. rubber, will be under tension in an operating position wherein it is pressed with its lip against the visor and preferably relaxed or unpressed, that is not under tension against the visor, when in a disengaged i.e. resting position, the inventors discovered it to be advantageous that when moving the wiper into the resting position, the wiper lip and wiper assembly are first disengaged from the visor before moving the wiper assembly to a parking slot separate from the visor. Similarly, vice versa, when moving to the operating position, the wiper assembly first moves towards the operating position before the wiper lip engages or contacts the visor. In this manner, the wiper blade lip is prevented from grating or scraping over an edge of the visor or over a transition of material between visor and sensor housing.

Further objects, aspects, effects and details of particular embodiments of the invention are described in the following detailed description of a number of exemplary embodiments, with reference to the drawings.

### BRIEF DESCRIPTION OF THE DRAWINGS

By way of example only, the embodiments of the present disclosure will be described with reference to the accompanying drawing, wherein:

FIG. 1 illustrates a perspective view of a vehicle roof with an example of a vehicle roof module;

FIG. 2 illustrates the vehicle roof module of FIG. 1 in more detail;

FIG. 3 illustrates in cross-section an example of a wiping assembly;

FIG. 4 illustrates components of an example of a slide in relation to a visor;

FIG. 5 is a bottom-up view of the components of FIG. 4;

FIG. 6A-6C illustrate top views of the slide of FIG. 5 in different positions;

FIGS. 7A-7C illustrates illustrate top views of another example of a slide in different positions; and

FIG. 8 illustrates another example of a vehicle roof module.

### DETAILED DESCRIPTION OF ILLUSTRATIVE EMBODIMENTS

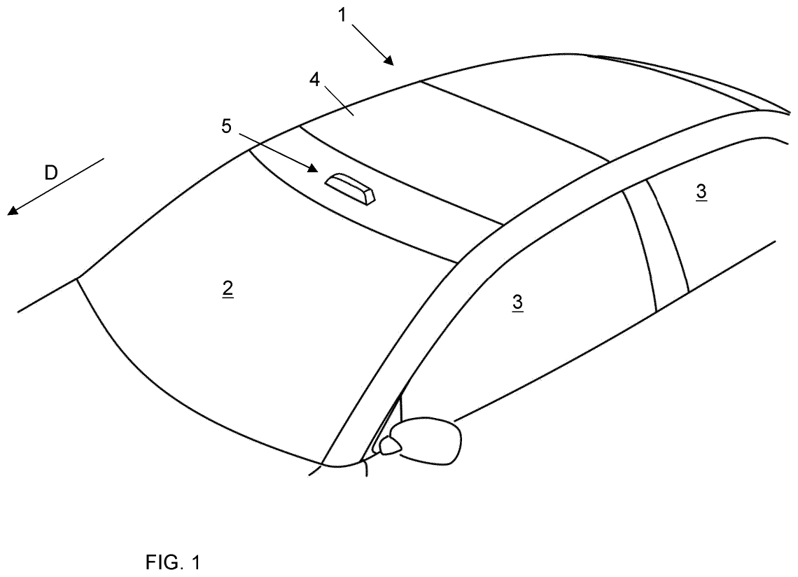

Referring to FIG. 1, a perspective view of an example of a vehicle roof is schematically illustrated. Further shown are vehicle front window 2, side windows 3 and an optional roof window 4. On top of the vehicle roof a vehicle roof module 5 is shown, also referred to as an external sensor module.

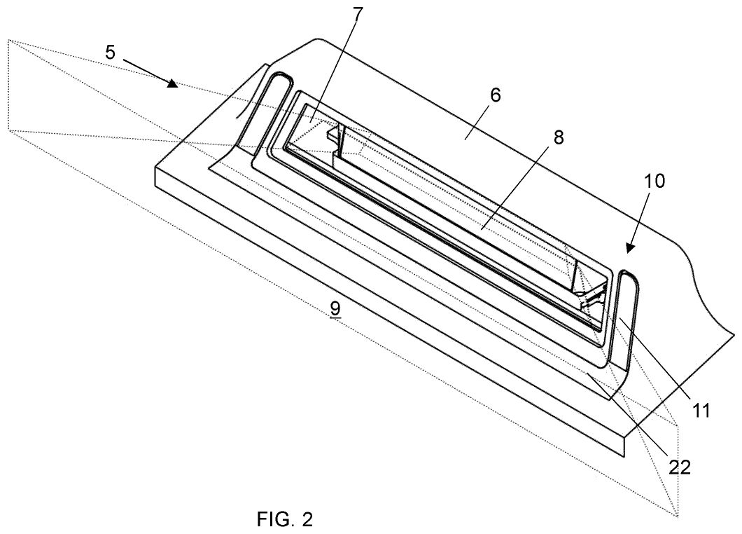

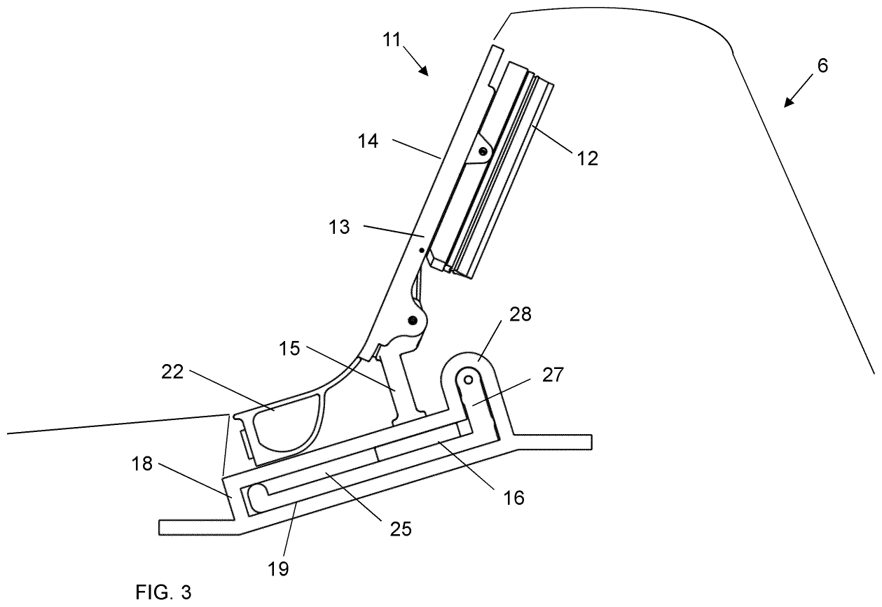

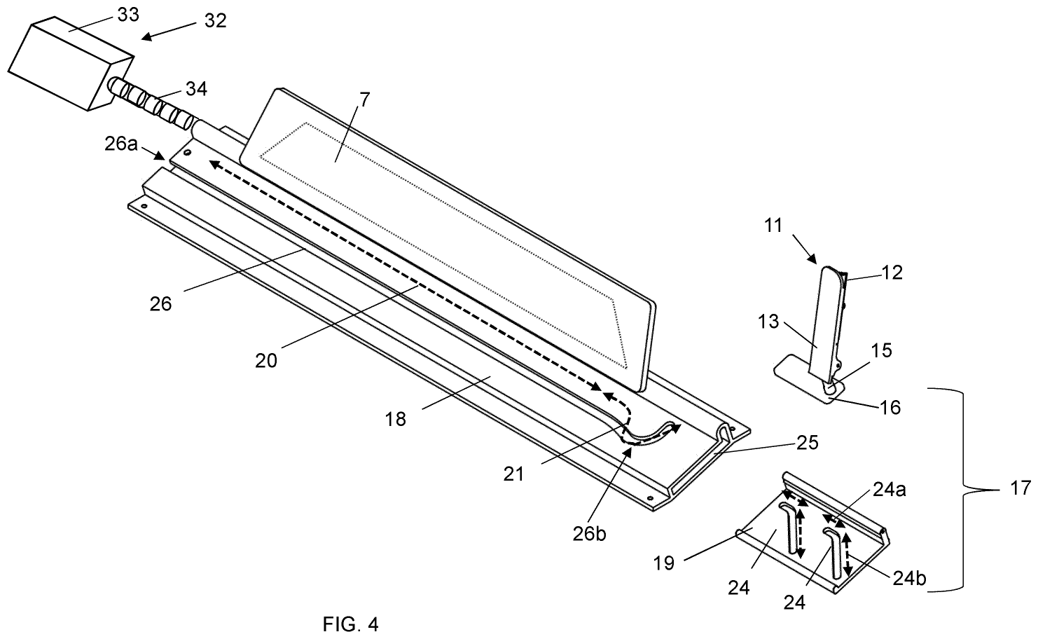

Referring to FIG. 2, the vehicle roof module 5 of FIG. 1 is shown in more detail. In this example the module 5 encloses a LiDAR sensor. The module 5 further includes a sensor housing 6 having a visor 7 or screen provided at a front side of the housing with reference to a forward driving movement of a vehicle, indicated by arrow D. The sensor housing 6 includes a sensor 8 which has a field of view 9 that is aligned with the visor, which alignment ensures that objects within its field of view 9 may be detected by the sensor. Within the sensor housing 6, adjacent to the side of the visor 7 is a parking slot 10. In this embodiment on one side of the visor, in other embodiments the parking slot may be on another side adjacent of the visor or on each side adjacent of the visor. The parking slot 10 provides a resting position for a wiper assembly 11, an example of which is shown in more detail in FIG. 3. The roof module 5 further includes a guide 18, in this embodiment running in front adjacent to the visor 7. The guide 18 defines a wiping path 20 and a parking path 21, as shown in FIG. 4. As shown in FIGS. 1 and 3, the guide 18 is covered by a seal 22. In this example a single flat tail seal, in other examples it may be a bulb seal.

The wiper assembly 11 shown in FIG. 3 has a wiper blade 12 that is mounted on a wiper arm 13. In this example, the wiper arm 13 is provided with a back cover 14 which is configured such that when the wiper assembly 11 is in the resting position in the parking slot 10, the back cover 14 is substantially flush with an outer surface of the sensor housing 6. In the embodiment of FIG. 3, the wiper arm 13 is hingeably mounted on a wiper rod 15 of a planar base 16. The wiper assembly may further include a tensioner for tensioning the wiper blade, or at least the lip of the wiper blade, against the visor 7 in an operating position. The tensioning means may be a torsion spring, coil spring, elastomeric material or other suitable means having an inclination to return to a default position after being moved out thereof. The tensioner may further include means for limiting the angle at which the wiper blade is positioned relative to the visor. This may ensure that when the wiper assembly is moved away from the visor, the wiper blade will disengage from the visor.

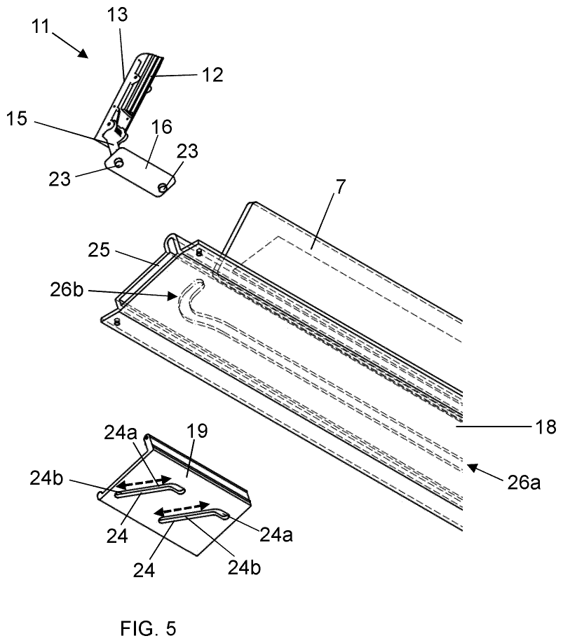

Referring to FIGS. 3-5, an example of a slide 17 of the roof module of FIG. 1 is shown. The slide 17 is configured for sliding the wiper assembly 11 over the wiping path 20 and over the parking path 21, each indicated by dotted lines in FIG. 4. The guide 18 and the slide 17 are configured such that when sliding the wiper assembly 11 over the wiping path 20 the wiper arm 13 slides along the sensor housing 6 such that the wiper blade 12 may wipe the visor 7. The guide 18 and the slide 17 are further configured such that when sliding the wiper assembly 11 over the parking path 21 the wiper arm 13 slides along the sensor housing 6 while the wiper blade 12 is lifted from the visor 7.

The slide 17 includes a planar base 16 having on one side at least one sliding pin, in this embodiment two sliding pins 23. On another side of the planer base 16 there is a rod, in this embodiment wiper rod 15, which is configured for carrying the wiper assembly 11. The slide 17 further includes a driven slider 19 having a pin sliding track 24 for each respective at least one sliding pin 23. Hence, in the embodiment of FIGS. 3-6 the slider 19 has two pin sliding tracks 24. Each pin sliding track 24 of the driven slider has a parking portion 24a and a wiping portion 24b. The parking portion refers to a part of the pin sliding track along which the pin will travel when moving the wiper assembly from the resting position towards the wiping position. Furthermore, the parking portion is where the pin will reside when the wiper assembly is in the parking slot. The wiping portion is where the pin will reside when the wiper assembly is in the wiping position.

The guide 18 includes a slider channel 25 for guiding the driven slider 19 parallel to the sensor housing 6. The driven slider 19 has a flat main body and the slider channel is adapted to the main body of the driven slider 19. The guide 18 further includes a rod guiding slot 26 for guiding the rod 15 along the wiping path 20 and the parking path 21. The rod guiding slot 26 has a straight wiping portion 26a and a curved parking portion 26b. The wiping portion 26a of the rod guiding slot 26 runs parallel to the visor 7 whereas the parking portion 26b runs away and around the visor 7. Hence, the guide 18 may determine the wiping path 20 and the parking path 21 by way of the shape of the respective wiping portions and parking portions of the rod guiding slot 26. While the pin sliding track or tracks 24 of the driven slider 19 determine the movement of the planar base 16 through the slider channel 25 in relation to the driven slider. As the rod is mounted on the base, the shape of the rod guiding slot and pin sliding track are intended to support and cooperate to obtain the desired kinematic pattern of the wiper assembly in relation to the visor of the sensor housing. Accordingly, when the driven slider moves parallel to the sensor housing through the slider channel, the at least one sliding pin is forced to move through the pin sliding track thereby moving the base, which movement of the base forces the rod to travel through the rod sliding track thereby moving the wiper assembly along the sensor housing and the visor. The shape and size of the rod guiding slot in the guide and the at least one pin sliding track in the driven slider are preferably configured such that the rod and at least one pin confine the base to defined positions that make up the parking path 20 and the wiping path 21. Thereby, they provide a predetermined trajectory for the wiper assembly mounted thereon.

Hence, the guide 18 and slide 17 are arranged such that when moving the driven slider 19 in the slider channel 25 along the wiping path 20, the at least one sliding pin 23 slides in the pin sliding track wiping portion 24b and the rod guiding track wiping portion 26a guides the wiper rod 15 parallel along the visor 7. Furthermore, when moving the driven slider 19 in the slider channel 25 along the parking path 21, the at least one sliding pin 23 slides in the pin sliding track parking portion 24a, and the rod guiding track parking portion 26b guides the wiper rod 15 at a deflection, in this embodiment a curve, along the visor 7.

In the embodiment of FIGS. 3-5, the slider channel 25 has a profile, in cross-section, with a recessed slide portion 28 extending in a longitudinal direction of the channel. As can be seen in the cross-section of FIG. 3, the recessed slide portion 28 is also perpendicular to the longitudinal plane of the slider channel 25. The slider 19, in this embodiment, further includes a raised wall or flange 27 that is intended to cooperate with the recessed portion 28 and to slide therethrough when the driven slider is moved through the channel. As seen in FIG. 3, the flange 27 protrudes perpendicular from a main body of the driven slider 19. The co-operative configuration of recessed portion 28 and flange 27 may prevent the driven slider 19 from skewing within the channel 25.

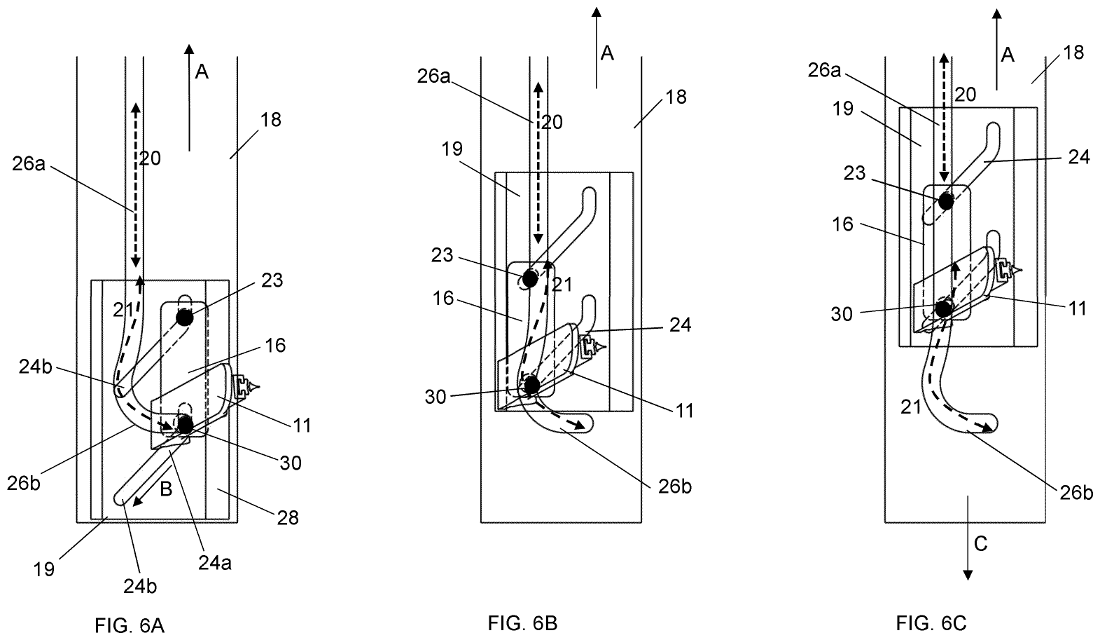

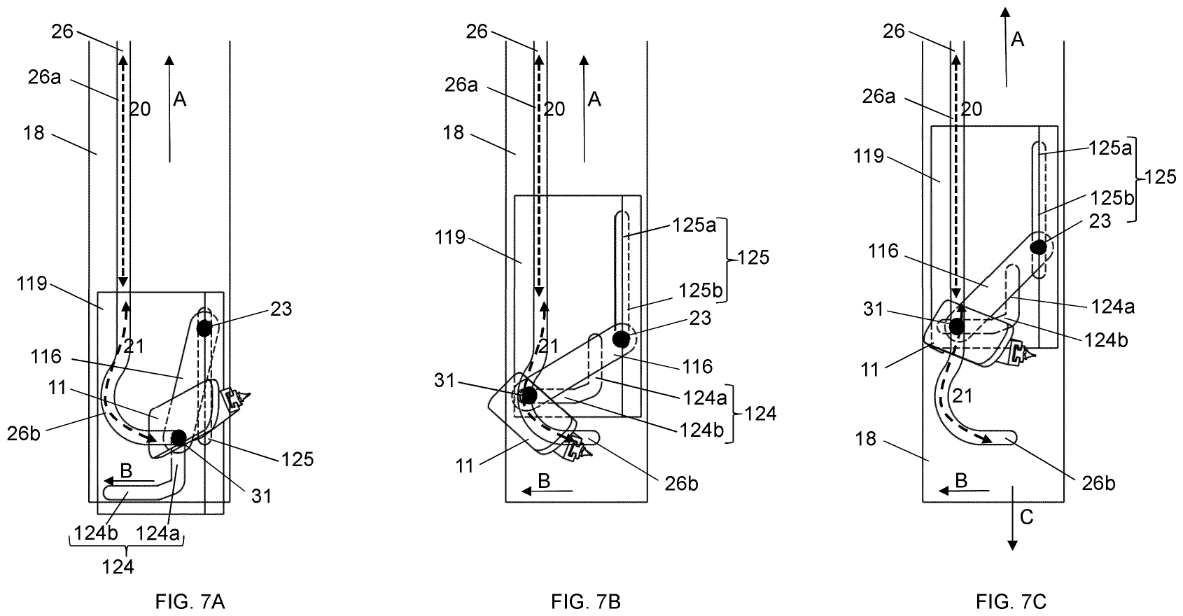

Referring to FIGS. 6A-6C, and 7A-C the kinematic movement of two different embodiments are clarified in more detail. The figures provide a top view with components at various layers being displayed in a transparent manner. Herein, the wiper assembly 11, guide 18 and slide formed by base 16 and driven slider 19 are shown in top-view. Herein, the components are illustrated in a transparent way in order to clarify the relative locations of various elements. As for example, the rod on the base 16 that carries the wiper assembly 11 would not be visible in a top view as it is underneath the wiper assembly, the relative location thereof is indicated by a circle 30. Similarly, only relative location of the base 16 itself within the guide 18 and the pins 23 underneath the base are indicated. In this example, circle 30 indicates the location of both the rod as one of the pins, as these are axially aligned with one another.

Referring to FIG. 6A, the wiper assembly 11 is in the resting position as when located in the parking slot. The rod 30 is within the curved parking portion 26b of the rod guiding slot. When the driven slider 19 is moved in the direction as indicated by arrow A, the pin sliding track will move relative to the pins, first the pins 23, 30 remain in place while the parking portions 24a moves in the direction of arrow A, then the pin sliding track parking portions 24b will force the pins 23, 30 to move in the direction of arrow B, towards the pin sliding track wiping portions 24b, thereby sliding the base 16. With the sliding of the base 16, the rod 30 will be moved along and move through the rod guiding slot through the curved parking portion 26b, thereby travelling along the parking path 21. Hence, the guiding of the rod through the rod guiding track parking portion 26b occurs simultaneously with the sliding of pins 23, 30 through the pin sliding parking portions 24a and pin sliding track wiping portions 24b consecutively. Referring to FIG. 6B, when the pins 23, 30 respectively are moved at outer ends of pin sliding track wiping portions 24b, the rod location 30 is still in the curved parking portion 26b of the rod guiding slot. Referring to FIG. 6C, when the driven slider 19 is moved still further in the direction of arrow A, the pins 23, 30 return from the respective outer ends of the pin sliding track wiping portions 24b, moving slightly inwards, while the rod location 30 will travel towards the wiping portion 26a of the rod guiding slot and will consequently be guided further through the wiping portion of the rod guiding slot. From thereon, the wiper assembly 11 is in the wiping position, wherein the wiper blade is in contact with the visor 7, and will further move along the wiping path 20 to wipe the visor.

Vice versa, in order to move the wiper assembly out of the wiping path 20 and into the parking slot 10 via the parking path 21, the location of the pin 23 and location of the pin and the rod 30 will follow the kinematic movement as described above with reference in reverse order from FIG. 6C to FIG. 6A. Herein the riven slider 19 will be moved in the direction of arow C.

Referring to FIGS. 7A-7C, another example of an embodiment of a slide and guide of a vehicle roof module are illustrated. Herein, similar elements are indicated with the same reference numbers as in FIGS. 6A-6C. In this embodiment base 116 is provided with two sliding pins, the location of which is indicated by circles 23 and 31. Circle 31 also indicates the location of the rod on the base 116. Correspondingly, the driven slider 119 has two pin sliding tracks 124, 125 which each include a pin sliding track parking portion 124a, 125a and a pin sliding track wiping portion 124b, 125b. In contrast to the embodiment of FIGS. 6A-6C wherein the pin sliding tracks run parallel to each other, in the embodiment of FIGS. 7A-7C the pin sliding tracks have different shapes. The parking portion 124a and wiping portion 124b of first sliding track 124 partially extend at an angle to one another, substantially perpendicular in this example, whereas the parking portion 125a and wiping portion 125b of second sliding track 125 extend in line with each other. Furthermore, parts of the parking portions 124a, 125a of the first and second sliding track 124, 125 run partially parallel to each other.

Referring to FIG. 7A, the wiper assembly 11 is again in the resting position as when located in the parking slot. The rod 31 is within the curved parking portion 26b of the rod guiding slot 26a, 26b. When the driven slider 119 is moved in the direction as indicated by arrow A, the pin sliding track will move relative to the pin 31, first the pin 31 remains in place while the parking portion 124a moves in the direction of arrow A, then the pin sliding track wiping portion 124b will force the pin 31 to move in the direction of arrow B, thereby rotating the base 116. With the rotating of the base 116, the rod 31 will be moved along and move through the rod guiding slot 26 through the curved parking portion 26b, thereby travelling along the parking path 21 as indicated by a dotted lined. Hence, the guiding of the rod through the rod guiding track parking portion 126b occurs simultaneously with the sliding of pin 31 through the pin sliding parking portion 124a and pin sliding track wiping portion 124b consecutively. Referring to FIG. 7B, when the pin 31 is at an outer end of pin sliding track wiping portion 124b, the rod location 31 is still in the curved parking portion 26b of the rod guiding slot. Referring to FIG. 7C, when the driven slider 119 is moved still further in the direction of arrow A, the pin 31 returns from the outer end of the pin sliding track wiping portion 124b, while the rod 31 will travel towards the wiping portion 26a of the rod guiding slot and will consequently be guided further through the wiping portion 26a of the rod guiding slot. From thereon, the base 116 slides in the direction of arrow A and the wiper assembly 11 is in the wiping position, wherein the wiper blade is in contact with the visor, and will further move along the wiping path 20 to wipe the visor.

As can be seen in the FIGS. 7A-7C, in contrast to the embodiment as shown in FIGS. 6A-6C, the base 116 rotates around pin 23 and the wiper assembly 11 mounted thereon will accordingly rotate in relation to the visor.

In each of the embodiments described, the roof module may further include a drive assembly 32, as e.g. shown in FIG. 4, configured for driving the driven slider 19,119, back and forth, through the slider channel of the guide 18. Thereto, the drive assembly 32 may include a motor 33 and a drive cable 34, the motor being arranged for operating the driven slider 19,119 by means of the drive cable 34. The motor may be any kind of electric motor capable of pulling and pushing the drive cable 34 in either direction. In order to address any tolerance of the drive assembly 32, as for example in the longitudinal driving direction, the parking portion of the pin sliding track 24, 124 may be partially straight, extending in the direction of travel of the driven slider.

To further control movement of the drive cable, for example to prevent coiling or convolving thereof, the drive cable may be fed through a rigid sleeve or gutter. Accordingly, the slider channel 25 may be provided with such a gutter. In the embodiment of FIGS. 3 and 4, the recessed slide portion 28 extending longitudinally within the slider channel 25 may function as drive cable gutter. Actuation of the motor drive and to start a wiping operation of the visor may be triggered by a signal from an electronic control unit. The control unit may receive a signal from e.g. a rain sensor, or a signal indicating a certain level of pollution of the visor, and respond to one of these signals by initiating the wiping operation.

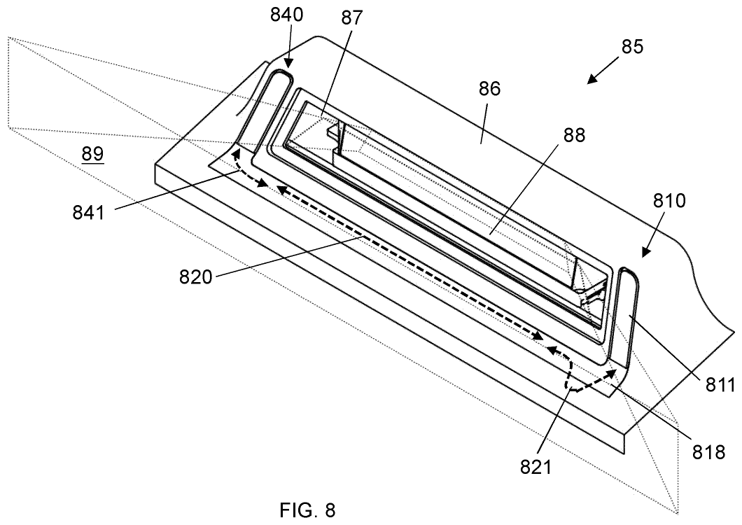

Referring to FIG. 8, another example of a vehicle roof module 85 is illustrated schematically. The module 85 also includes sensor housing 86 having a visor 87 provided at a front side of the housing. The sensor housing 86 again includes a sensor 88 which has a field of view 89 that is aligned with the visor 87. Within the sensor housing 86, adjacent to the side of the visor 87 is the first parking slot 810 and to another side adjacent to the visor 87 there is an additional, second parking slot 840. The parking slots 810, 840 each provide resting positions for the wiper assembly 811 as described above. Also this roof module 85 includes a guide 818 running in front adjacent to the visor 87. The guide 818 defines the wiping path 820 and parking path 21, and an additional parking path 841. The additional parking path 841 runs between the second parking slot 840 and the wiping path 820. In this example, a slide is configured for sliding the wiper assembly 11 over the guide 818 along the wiping path 820. The slide is further configured for sliding over the-now first-parking path 821, and over the additional parking path 841. Similar as described for the above examples of FIGS. 6A-C and 7A-C, sliding the wiper assembly 11 over the wiping path 20 slides the wiper arm 13 along the sensor housing 6 such that the wiper blade 12 wipes the visor 7. Furthermore, sliding the wiper assembly 11 either over the first parking path 821 or over the additional parking 841 path, slides the wiper arm 13 along the sensor housing 86 while the wiper blade 12 is lifted from the visor 87.

In another example of a vehicle roof module, instead of a second parking slot as in the example of FIG. 8, the space next to the visor may be used to arrange a nozzle on one side and one parking slot on the other side next to the housing. The nozzle may be mounted for example on a telescopic arm or other means for movably protruding from the side. A door or cover may be arranged to close off the nozzle slot when not in use and provide an aerodynamic smooth surface.

Although the present invention has been described above with reference to specific embodiments, it is not intended to be limited to the specific form set forth herein. Rather, the invention is limited only by the accompanying claims and, other embodiments than the specific above are equally possible within the scope of these appended claims.

Furthermore, although exemplary embodiments have been described above in some exemplary combination of components and/or functions, it should be appreciated that, alternative embodiments may be provided by different combinations of members and/or functions without departing from the scope of the present disclosure. In addition, it is specifically contemplated that a particular feature described, either individually or as part of an embodiment, can be combined with other individually described features, or parts of other embodiments.

What is claimed is:

1. A vehicle roof module for a sensor, comprising:
a wiper assembly comprising a wiper blade carried on a wiper arm;
a sensor housing comprising a visor;
a guide defining a wiping path and a parking path; and
a slide configured to slide the wiper assembly over the guide along the wiping path and the parking path,
wherein the wiper arm slides along the sensor housing such that the wiper blade wipes the visor, and
wherein the wiper arm slides along the sensor housing while the wiper blade is lifted from the visor.

2. The vehicle roof module according claim 1, wherein the slide comprises:
a planar base comprising on one side at least one sliding pin and on another side a wiper rod configured to carry the wiper assembly; and
a driven slider comprising a pin sliding track for each respective at least one sliding pin; and
wherein the guide comprises:
a slider channel configured to guide the driven slider parallel to the sensor housing; and
a rod guiding slot configured to guide the wiper rod along the wiping path and the parking path.

3. The vehicle roof module according to claim 2,
wherein the rod guiding slot has a straight wiping portion and a curved parking portion; and
wherein the pin sliding track has a parking portion and a wiping portion.

4. The vehicle roof module according to claim 3,
wherein, when moving the driven slider in the slider channel along the wiping path, the at least one sliding pin slides in the wiping portion of the pin sliding track and the wiping portion of the rod guiding slot guides the wiper rod parallel along the visor; and
wherein, when moving the driven slider in the slider channel along the parking path, the at least one sliding pin slides in the parking portion of the pin sliding track, and the parking portion of the rod guiding slot guides the wiper rod at a deflection along the visor.

5. The vehicle roof module according to claim 1, wherein the sensor housing further comprises a parking slot adjacent to the visor providing a resting position for the wiper assembly; and
wherein the wiper assembly slides over the parking path between the resting position in the parking slot and an operating position on the wiping path.

6. The vehicle roof module according to claim 5,
wherein in the resting position the wiper assembly rests within the parking slot with the wiper blade disengaged from the visor; and
in the operating position the wiper assembly engages the visor with the wiper blade.

7. The vehicle roof module according to claim 5, wherein, when sliding over the parking path out of the operating position and towards the resting position, the wiper blade is lifted from the visor while the wiper assembly slides further along the sensor housing.

8. The vehicle roof module according to claim 2, wherein the slider channel comprises a recessed slide portion.

9. The vehicle roof module according to claim 5, wherein the wiper assembly further comprises a tensioner configured to tension the wiper blade against the visor in the operating position.

10. The vehicle roof module according to claim 8, further comprising a drive assembly configured to drive the driven slider through the guide.

11. The vehicle roof module according to claim 10, wherein the drive assembly comprises a motor and a drive cable, the drive cable connecting the driven slider to the motor.

12. The vehicle roof module according to claim 11, wherein the slider channel comprises a drive cable gutter for the drive cable.

13. The vehicle roof module according to claim 12, wherein the recessed slide portion of the slider channel comprises the drive cable gutter for the drive cable.

14. The vehicle roof module according to claim 1, further comprising a sensor having a field of view aligned with the visor.

15. The vehicle roof module according to claim 1,
wherein the sensor housing comprises a second parking slot on another side of the visor;
wherein the guide further defines an additional parking path, running between the second parking slot and the wiping path;
wherein the slide is further configured to slide the wiper assembly over the guide along the wiping path and the additional parking path; and
wherein sliding the wiper assembly over the additional parking path slides the wiper arm along the sensor housing while the wiper blade is lifted from the visor.
